(19) United States
(12) Patent Application Publication
(10) Pub. No.: US 2003/0072133 A1
(43) Pub. Date: Apr. 17, 2003

(54) Auxiliary apparatus for personal digital assistants

(75) Inventor: Wei-Pin Chuang, Taipei City (JP)

Correspondence Address: FOLEY AND LARDNER, SUITE 500, 3000 K STREET NW, WASHINGTON, DC, 20007, US

(73) Assignee: COMPAL ELECTRONICS, INC.

(21) Appl. No.: 09/989,439

(22) Filed: Nov. 21, 2001

(30) Foreign Application Priority Data
Oct. 16, 2001 (TW) 9021625

(51) Int. Cl. G06F 1/16

(52) U.S. Cl. 361/686

(57) ABSTRACT

An auxiliary apparatus includes a circuit unit disposed in a housing that is formed with a recess for receiving a personal digital assistant, and a connector mounted on the housing, disposed in the recess, and coupled electrically to the circuit unit. The connector is adapted to couple electrically and directly with the personal digital assistant so as to be able to provide an audio signal from the personal digital assistant to the circuit unit when the personal digital assistant is received in the recess. A loudspeaker unit is mounted in the housing and is coupled electrically to the circuit unit. The circuit unit enables the loudspeaker unit to reproduce the audio signal received by the connector.

### BACKGROUND OF THE INVENTION

1. Field of the Invention

The invention relates to an auxiliary apparatus for a personal digital assistant, more particularly to an auxiliary apparatus that can reproduce audio signals from a personal digital assistant.

2. Description of the Related Art

FIG. 1A illustrates a conventional synchronization base 5 for a personal digital assistant 4, which can connect the personal digital assistant 4 to a computer 6 for data transmission between the personal digital assistant 4 and the computer 6. FIG. 1B illustrates a conventional expansion base 5′ for a personal digital assistant 4, which can connect the personal digital assistant 4 to a peripheral equipment (not shown) for expanding utility of the personal digital assistant 4. However, because the personal digital assistant 4 is designed to have a compact size, it fails to provide a relatively large resonant space for a loudspeaker 41 disposed therein such that the personal digital assistant 4 generates an inferior audio output when not used with any external loudspeaker.

### SUMMARY OF THE INVENTION

Therefore, the object of the present invention is to provide an auxiliary apparatus that permits superior reproduction of audio signals from a personal digital assistant.

According to the present invention, an auxiliary apparatus is adapted for use with a personal digital assistant, and comprises:

a housing formed with a recess that is adapted for receiving the personal digital assistant;

a circuit unit disposed in the housing;

a connector mounted on the housing, disposed in the recess, and coupled electrically to the circuit unit, the connector being adapted to couple electrically and directly with the personal digital assistant so as to be able to provide an audio signal from the personal digital assistant to the circuit unit when the personal digital assistant is received in the recess; and

a loudspeaker unit mounted in the housing and coupled electrically to the circuit unit, the circuit unit enabling the loudspeaker unit to reproduce the audio signal received by the connector.

### BRIEF DESCRIPTION OF THE DRAWINGS

Other features and advantages of the present invention will become apparent in the following detailed description of the preferred embodiments with reference to the accompanying drawings, of which:

FIG. 1A is a perspective view of a conventional auxiliary apparatus for a personal digital assistant;

FIG. 1B is a perspective view of another conventional auxiliary apparatus for a personal digital assistant;

FIG. 2 is a perspective view showing the first preferred embodiment of an auxiliary apparatus according to this invention;

FIG. 2A is a schematic circuit block diagram of the first preferred embodiment;

FIG. 3 is a perspective view showing the second preferred embodiment of an auxiliary apparatus according to this invention; and

FIG. 3A is a schematic circuit block diagram of the second preferred embodiment.

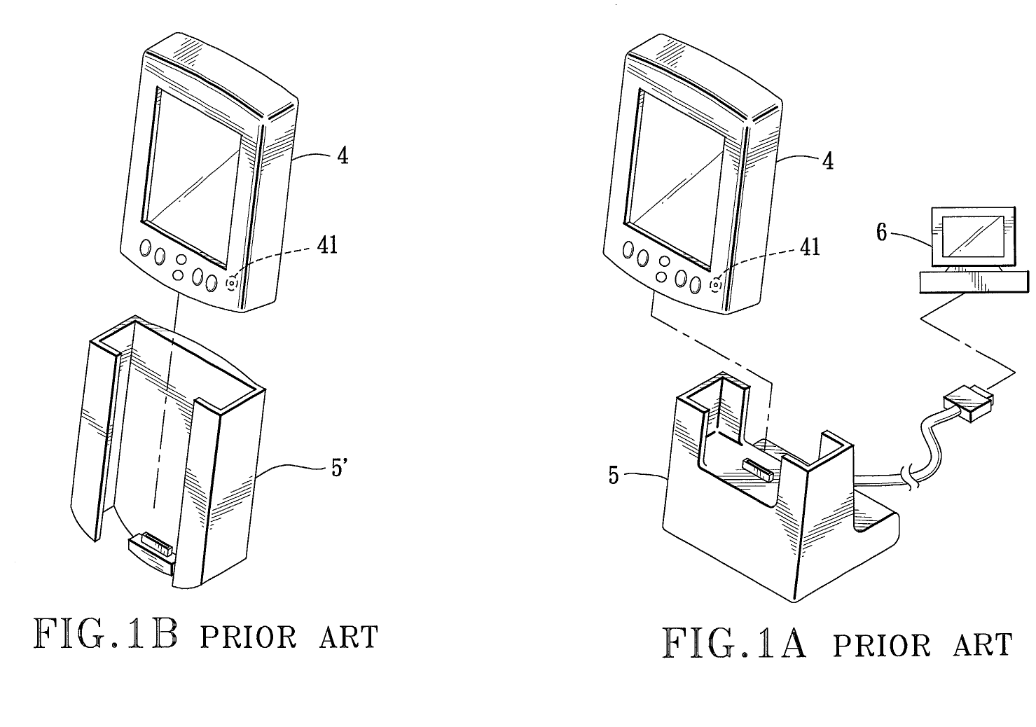

### DETAILED DESCRIPTION OF THE PREFERRED EMBODIMENTS

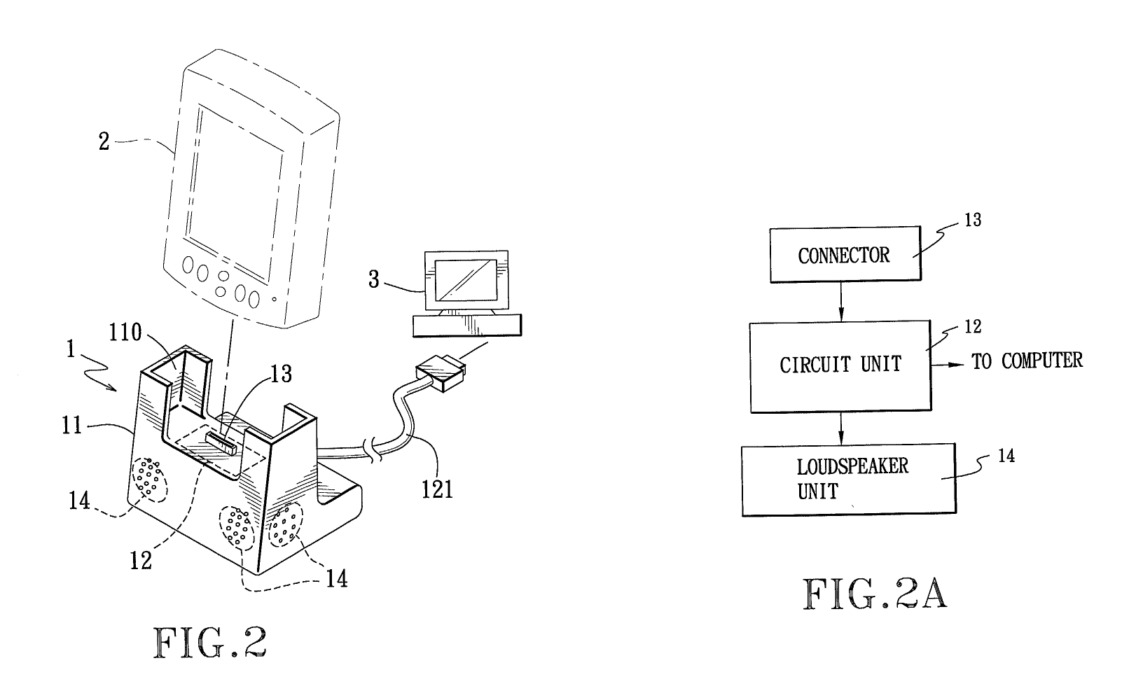

Referring to FIGS. 2 and 2A, the first preferred embodiment of an auxiliary apparatus 1 according to the present invention is shown to be embodied in a synchronization base for a personal digital assistant 2. The auxiliary apparatus 1 includes a housing 11, a circuit unit 12, a connector 13, and a loudspeaker unit 14.

The housing 11, which is made of plastic, is formed with a recess 110 that is adapted for receiving the personal digital assistant 2.

The circuit unit 12 is disposed in the housing 11, and is adapted to be coupled electrically to a computer 3 via a cable 121 so as to be adapted to transmit and receive signals to and from the computer 3.

The connector 13 is mounted on the housing 11, is disposed in the recess 110, and is coupled electrically to the circuit unit 12. The connector 13 is adapted to couple electrically and directly with the personal digital assistant 2 so as to be able to provide an audio signal from the personal digital assistant 2 to the circuit unit 12, and so that the signals received by the circuit unit 12 via the cable 121 can be provided to the personal digital assistant 2 when the personal digital assistant 2 is received in the recess 110.

In this embodiment, the loudspeaker unit 14 includes a pair of loudspeakers that are mounted in the housing 11. The loudspeaker unit 14 is coupled electrically to the circuit unit 12. The circuit unit 12 enables the loudspeaker unit 14 to reproduce the audio signal received by the connector 13.

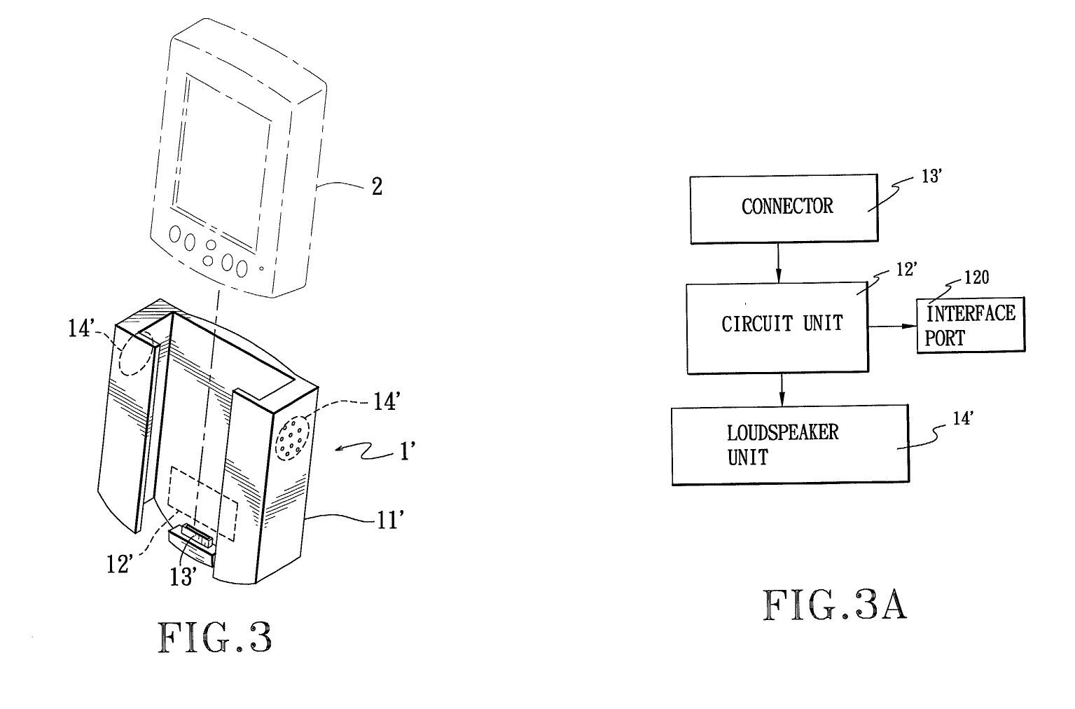

FIG. 3 illustrates the second preferred embodiment of an auxiliary apparatus 1′, which is embodied in an expansion base for a personal digital assistant 2, according to this invention, which is a modification of the first preferred embodiment. Unlike the previous embodiment, with further reference to FIG. 3A, in addition to the housing 11′, the circuit unit 12′, the connector 13′ and the loudspeaker unit 14′, the auxiliary apparatus 1′ further includes an interface port 120. The interface port 120 is coupled electrically to the circuit unit 12′, and is adapted to be connected electrically to other peripheral equipment (not shown).

Since the housing 11, 11′ has a larger internal resonant space therein as compared to the personal digital assistant 2, the auxiliary apparatus 1, 1′ of the present invention can provide a superior resonant effect for the loudspeaker unit 14, 14′. Therefore, due to the inclusion of the loudspeaker unit 14, 14′, the auxiliary apparatus 1, 1′ of the present invention permits a superior reproduction of the audio signals from the portable digital assistant 2. The object of the invention is thus met.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An auxiliary apparatus for a personal digital assistant, said auxiliary apparatus comprising:
a housing formed with a recess that is adapted for receiving the personal digital assistant;
a circuit unit disposed in said housing;
a connector mounted on said housing, disposed in said recess, and coupled electrically to said circuit unit, said connector being adapted to couple electrically and directly with the personal digital assistant so as to be able to provide an audio signal from the personal digital assistant to said circuit unit when the personal digital assistant is received in said recess; and
a loudspeaker unit mounted in said housing and coupled electrically to said circuit unit, said circuit unit enabling said loudspeaker unit to reproduce the audio signal received by said connector.
